(19) United States
(12) Patent Application Publication
(10) Pub. No.: US 2008/0205252 A1
(43) Pub. Date: Aug. 28, 2008

(54) FERROELECTRIC INFORMATION STORAGE MEDIUM AND METHOD OF MANUFACTURING THE SAME

(75) Inventors: Simon Buehlmann, Yongin-si (KR); Eun-joo Jang, Suwon-si (KR); Shin-ae Jun, Seongnamsi (KR); Seung-bum Hong, Seongnam-si (KR); Yong-kwan Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/872,059

(22) Filed: Oct. 15, 2007

(30) Foreign Application Priority Data
Feb. 23, 2007 (KR) 10-2007-0018521

(51) Int. Cl. G11B 9/02

(52) U.S. Cl. 369/126

(57) ABSTRACT

A ferroelectric information storage medium having ferroelectric nanodots and a method of manufacturing the ferroelectric information storage medium are provided. The ferroelectric information storage medium includes a substrate, an electrode formed on the substrate, and ferroelectric nanodots formed on the electrode, wherein the ferroelectric nanodots are separated from each other, and a plurality of the ferroelectric nanodots form a single bit region.

### CROSS-REFERENCE TO RELATED PATENT APPLICATIONS

This application claims priority from Korean Patent Application No. 10-2007-0018521, filed on Feb. 23, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to a ferroelectric information storage medium having a ferroelectric material for storing information and, more particularly, to a ferroelectric information storage medium having a ferroelectric nanodot layer which is an information storage unit and a method of manufacturing the ferroelectric information storage medium.

2. Description of the Related Art

Due to the rapid development of data storage devices such as conventional hard disks and optical disks, information storage media having a recording density of 180 Gbit/inch² or above have been developed. However, the rapid development of digital techniques requires a further increased capacity of information storage media.

The recording density of a conventional hard disk is limited due to superparamagnetic limitations or diffraction limitations of a laser of an optical disk. Recently, research has been conducted to develop an information storage medium having a recording density of 100 Gbit/inch² or above by overcoming the diffraction limitation of light using a near-field optic technique. Also, in the case of a hard disk drive (HDD), a recording density of 400 Gbit/inch² has been demonstrated using discrete track media.

Meanwhile, research has been conducted to manufacture a high capacity information storage medium unlike a conventional information storage medium, using tip-shaped probes that may be viewed using an atomic force microscopy (AFM). Since the tip-shaped probes may be manufactured to a size of a few nm, an atomic level of a surface structure may be observed using the tip-shaped probes. When the tip-shaped probes having the above characteristics are used, information storage media with a tera bit level capacity per square inch may theoretically be manufactured. However, when a tip-shaped probe is used, the conventional ferroelectric thin film may have poor data retention characteristics in the information storage medium due to non-uniformity of the crystal size of polycrystals of the conventional ferroelectric thin film.

### SUMMARY OF THE INVENTION

To address the above and/or other problems, the present invention provides a ferroelectric information storage medium having an information storage layer formed of uniform size ferroelectric nanodots.

The present invention also provides a method of manufacturing the ferroelectric information storage medium.

According to an aspect of the present invention, there is provided a ferroelectric information storage medium, comprising: a substrate; an electrode formed on the substrate; and ferroelectric nanodots formed on the electrode, wherein the ferroelectric nanodots are separated from each other, and a plurality of the ferroelectric nanodots form a single bit region.

The ferroelectric nanodots may have a diameter of 15 nm or less.

The ferroelectric nanodots may be formed in a monolayer on the electrode.

The ferroelectric nanodots may be formed of at least one selected from PbTiO₃, KNbO₃, and BiFeO₃.

The substrate may be formed of at least one of silicon, glass and aluminium.

The ferroelectric information storage medium may further comprise a protective layer on the ferroelectric nanodots.

The ferroelectric information storage medium may further comprise a lubricating layer on the protective layer.

According to another aspect of the present invention, there is provided a method of manufacturing a ferroelectric information storage medium, comprising: a) forming an electrode on a substrate; b) forming a precursor nanodot layer that comprises a metal material for forming a ferroelectric material on the electrode; c) supplying a reaction gas to the precursor nanodot layer to cause a reaction with precursor nanodots of the precursor nanodot layer to form ferroelectric nanodots; and d) forming the ferroelectric nanodots by annealing the precursor nanodot layer.

The forming of the precursor nanodot layer may comprise coordinating an organic dispersion agent on a surface of each of the precursor nanodots of the precursor nanodot layer.

The precursor nanodot layer may be formed of a plurality of precursor nanodots separated from each other.

The precursor nanodots may have a diameter of 15 nm or less.

The forming of the precursor nanodot layer may comprise thin-filming a solution in which precursor nanodots are dispersed on the electrode.

The thin-filming may be performed using at least one selected from a group consisting of spin coating, dip coating, blade coating, screen printing, chemical self-assembling, Langmuir-Blodgett method, and spray coating.

The solution may comprise the precursor nanodots with a concentration of 0.05 to 1 wt %.

A solvent of the solution may be at least one organic solvent selected from chloroform, dichloromethane, hexane, toluene, ether, acetone, ethanol, pyridine, and tetrahydrofuran.

The precursor nanodot layer may be a monolayer of the precursor nanodots.

The forming of the precursor nanodot layer may further comprise removing the organic dispersion agent.

The removing of the organic dispersion agent may comprise annealing the precursor nanodot layer or O₂ plasma processing the precursor nanodot layer.

The forming of the precursor nanodot layer may comprise forming precursor nanodots comprising at least one selected from Ti, Nb, and Fe.

The forming of the ferroelectric nanodots may comprise annealing at a temperature of 400 to 900° C.

The forming of the ferroelectric nanodots may comprise forming the nanodot layer of at least one selected from PbTiO₃, KNbO₃, and BiFeO₃.

### BRIEF DESCRIPTION OF THE DRAWINGS

The above and other features and aspects of the present invention will become more apparent by describing in detail exemplary embodiments thereof with reference to the accompanying drawings, in which:

FIG. 1 is a cross-sectional view illustrating a ferroelectric information storage medium having a ferroelectric nanodot layer according to an exemplary embodiment of the present invention;

FIG. 2 is a diagram illustrating the disposition of the ferroelectric nanodots of FIG. 1;

FIGS. 3A through 3D are cross-sectional views illustrating a method of manufacturing a ferroelectric information storage medium having ferroelectric nanodots according to an exemplary embodiment of the present invention;

FIG. 4 is a transmission electron microscope (TEM) image showing the size and shape of TiO₂ nanodots; and

FIG. 5 is a schematic drawing showing the coordination of a dispersion agent having carboxyl radicals on a surface of TiO₂ nanodots.

### DETAILED DESCRIPTION OF EXEMPLARY EMBODIMENTS OF THE INVENTION

A ferroelectric information storage medium having a ferroelectric nanodots and a method of manufacturing the ferroelectric information storage medium consistent with the present invention will now be described more fully with reference to the accompanying drawings in which exemplary embodiments of the invention are shown. In the drawings, the thicknesses of layers and regions are exaggerated for clarity.

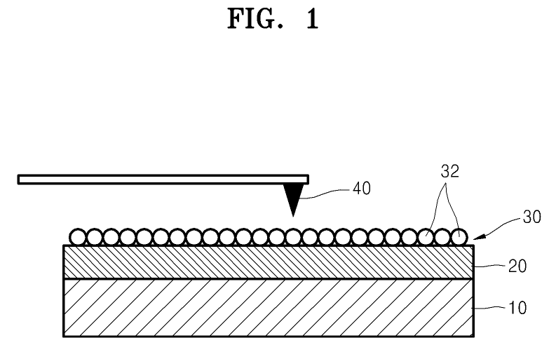

FIG. 1 is a cross-sectional view illustrating a ferroelectric information storage medium having a ferroelectric nanodot layer according to an exemplary embodiment of the present invention;

Referring to FIG. 1, an electrode 20 is formed on a substrate 10. While the electrode 20 is shown as a lower electrode, it is not limited to this orientation. A ferroelectric nanodot layer 30 formed of ferroelectric nanodots 32 is formed on the electrode 20. The ferroelectric nanodots 32 are uniformly distributed. An adhesive material (not shown) such as TiO₂, ZrO₂, or Cr may further be included between the substrate 10 and the electrode 20 to increase adhesiveness therebetween. Also, an adhesive material (not shown) such as the adhesive material described above may further be included between the electrode 20 and the ferroelectric nanodots 32.

The substrate 10 may be, for example, a silicon substrate which is widely used in the semiconductor industry, and also, may be a glass substrate or alumina substrate.

The electrode 20 may be formed of, for example, Pt, Ir, IrO₂, or SrRuO₃.

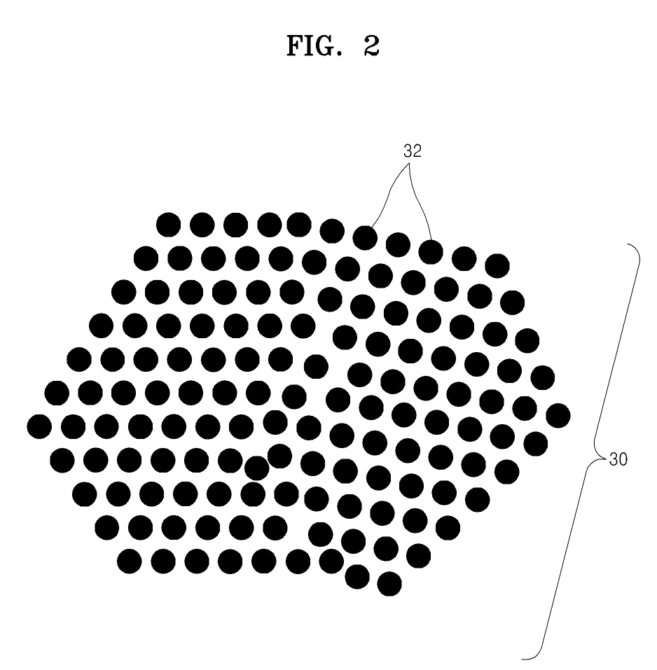

The ferroelectric nanodots 32 are formed of a ferroelectric material, for example, PbTiO₃, and are separated from each other as shown in FIG. 2. As will be described later in a method of manufacturing a ferroelectric information storage medium having ferroelectric nanodots, the size of the ferroelectric nanodots 32 may be uniformly formed. The ferroelectric nanodots 32 may have a diameter of 15 nm or less, and the gaps between the ferroelectric nanodots 32 may be controlled. The ferroelectric nanodots 32 are formed with a predetermined gap therebetween spontaneously formed in a manufacturing process, and do not necessarily have to have an aligned structure. A plurality of nanodots 32 becomes an information region of 1 bit. When the ferroelectric nanodots 32 are formed in a diameter of a few nm, an information region of 1 tera bit per inch² may be formed. Accordingly, the information storage medium consistent with the present embodiment has a much higher recording density than a conventional information storage medium.

The ferroelectric nanodots 32 are not limited to PbTiO₃ nanodots. That is, a ferroelectric material such as BiFeO₃ or KNbO₃ may also be used to form the ferroelectric nanodots 32.

The ferroelectric nanodot layer 30 is formed in a monolayer. A protective layer (not shown) may further be formed on the ferroelectric nanodot layer 30. The protective layer may be, for example, a diamond-like carbon (DLC) layer, or another material layer formed of various materials. A lubricating layer (not shown) may further be formed on the protective layer.

A write/read head 40 in FIG. 1 may be a resistive probe or a write/read head of a hard disk drive (HDD). When a pulse voltage is applied between the write/read head 40 and the electrode 20, the polarization of the ferroelectric nanodots 32 may be changed. According to the polarity of the applied voltage, the direction of the polarization of the ferroelectric nanodots 32 is upwards or downwards. The polarization state of the ferroelectric nanodots 32 may be read by the write/read head 40, and thus, recorded data in 1 bit regions formed of the ferroelectric nanodots 32 may be read.

The structure of the information storage medium consistent with the present embodiment may be clearly understood from the following method of manufacturing thereof.

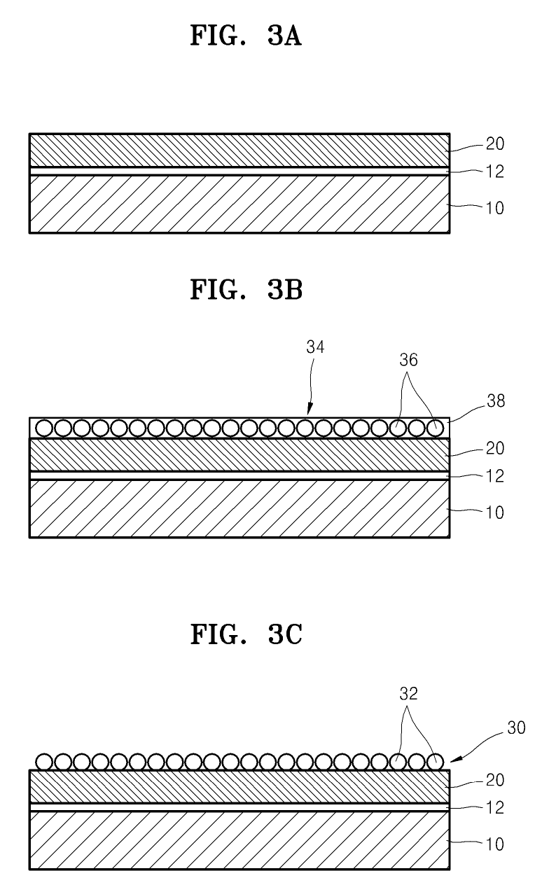

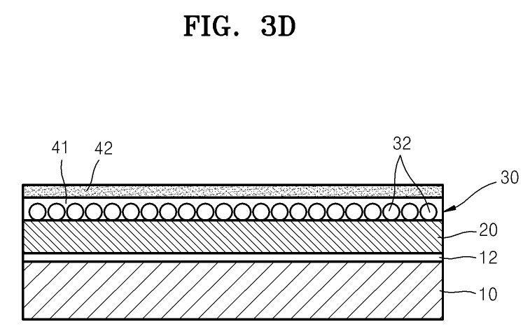

FIGS. 3A through 3D are cross-sectional views illustrating a method of manufacturing a ferroelectric information storage medium having ferroelectric nanodots according to an exemplary embodiment of the present invention. Like reference numerals are used to indicate elements that are substantially identical to the elements of FIG. 1, and thus, detailed descriptions thereof will not be repeated.

Referring to FIG. 3A, an adhesive layer 12 is formed on a substrate 10 and an electrode 20 is formed on the adhesive layer 12. The substrate 10 may be, for example, a silicon substrate, a glass substrate, or an alumina substrate. If a silicon substrate is used, an SiO₂ layer may be formed on the substrate 10. The adhesive layer 12 increases adhesiveness between the substrate 10 and the electrode 20 and may be formed by depositing an adhesive material such as TiO₂, ZrO₂, or Cr. The electrode 20 may be formed to a thickness of 100 nm or less by depositing a material such as Pt, Ir, IrO₂, or SrRuO₃.

Referring to FIG. 3B, a precursor nanodot layer 34 that includes a metal material for forming a ferroelectric material is formed on the electrode 20. The precursor nanodot layer 34 is formed of a plurality of precursor nanodots 36, and the precursor nanodots 36 are separated from each other in a similar manner to the ferroelectric nanodots 32 depicted in FIG. 2. A solution where the precursor nanodots 36 are dispersed by an organic dispersion agent 38 is thin-filmed on the electrode 20 to form the precursor nanodot layer 34. The ferroelectric material may be, for example, PbTiO₃, KNbO₃, or BiFeO₃. The metal for forming the ferroelectric material may be Ti, Nb, or Fe, and nitrides or oxides of these metals may form the ferroelectric material.

The thin-filming process may be performed using, for example, one of spin coating, dip coating, blade coating, screen printing, chemical self-assembling, Langmuir-Blodgett method, and spray coating.

The organic dispersion agent 38 is coordinated on surfaces of the precursor nanodots 36, and the precursor nanodots 36 are separated from each other by the organic dispersion agent 38. The precursor nanodots 36 may be formed to a diameter of 15 nm or less, and formed in a monolayer.

Next, a method of forming TiO₂ nanodots on the electrode 20 will now be described.

The TiO₂ nanodots are synthesized in a solution as follows. 0.4 g of oleic acid, 20 ml of trioctylamine, 1 ml of oleylamine, and 0.1 g of titanium chloride are simultaneously mixed in a flask in which a reflux condenser is installed by slowly increasing a reaction temperature to 320° C., and the reaction of the reaction mixture is maintained at the reaction temperature of 320° C. for 2 hours. After the reaction is completed, the reaction mixture is cooled as rapidly as possible, and is centrifugally separated by adding acetone which is a non-solvent. Liquid on an upper part of the reaction mixture except the centrifugally separated precipitate is discarded, and the precipitate is dispersed in hexane to obtain a solution of approximately 1 wt %. One organic solvent of, for example, chloroform, dichloromethane, hexane, toluene, ether, acetone, ethanol, pyridine, and tetrahydrofuran may be used instead of the hexane, a solvent of the solution.

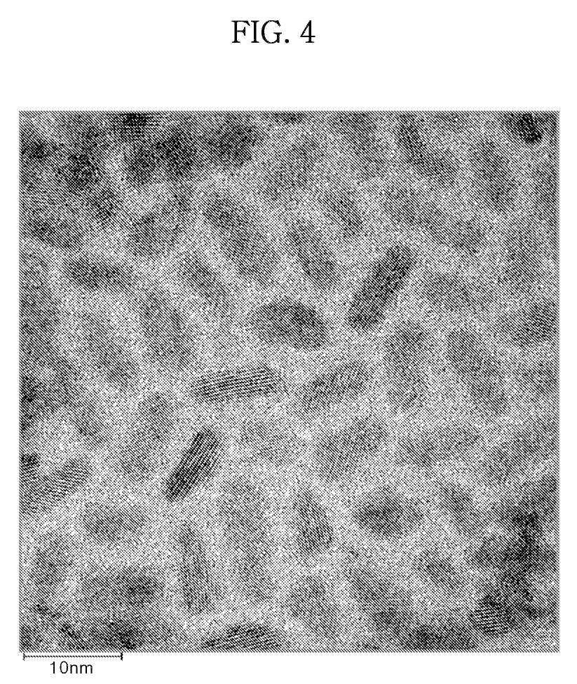

FIG. 4 shows a transmission electron microscope (TEM) image of TiO₂ nanodots manufactured using this method.

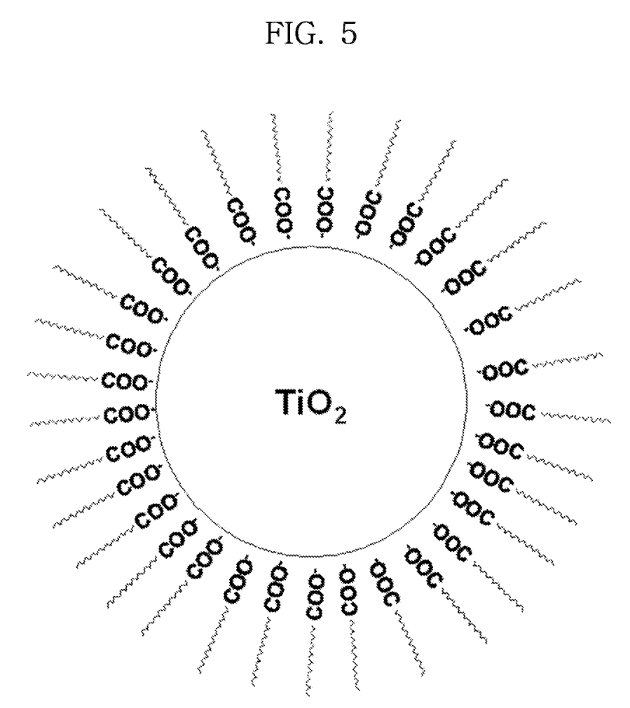

FIG. 5 is a schematic drawing showing the coordination of a dispersion agent having carboxyl radicals on a surface of the TiO₂ nanodots. As depicted in FIG. 5, surfaces of the TiO₂ nanodots are surrounded by oleic acid radicals. The solution in which the TiO₂ nanodots are dispersed is spin coated on the electrode 20. At this point, a monolayer of TiO₂ nanodots is formed by controlling the rate of spin coating, concentration of TiO₂ nanodots, or type of solvent. The TiO₂ nanodots spin coated on the electrode 20 are spontaneously separated and self-assembled by the oleic acid that surrounds the surfaces of the TiO₂ nanodots. That is, the self-assembly is not a precise alignment, but maintains certain gaps between each of the TiO₂ nanodots.

The concentration of the TiO₂ nanodots may be 0.05 to 1 wt %. If the concentration of the TiO₂ nanodots is lower than 0.05 wt %, gaps between the TiO₂ nanodots may be large, and thus the density of the TiO₂ nanodots may be reduced. If the concentration of the TiO₂ nanodots is higher than 1 wt %, the TiO₂ nanodot layer may be formed to be thick, and thus it is difficult to form a TiO₂ nanodot monolayer.

Next, the organic dispersion agent 38 coordinated on the surfaces of the precursor nanodots 36 is removed. The organic dispersion agent 38 may be removed by processing with O₂ plasma for 1 to 5 minutes or in an annealing process in a subsequent process.

Referring to FIG. 3C, in order to transform the precursor nanodots 36 to ferroelectric nanodots 32, the precursor nanodots 36 formed of TiO₂ are reacted with a PbO reaction gas. For precursor nanodots 36 formed of a different material, a different reaction gas is used. For example, if the precursor nanodots 36 are Ti precursor nanodots or TiN precursor nanodots, oxygen gas is further supplied. If the precursor nanodots 36 are FeO precursor nanodots, a Bi₂O₃ reaction gas is used, and if the precursor nanodots 36 are NbO precursor nanodots, a K₂O reaction gas is used. If the precursor nanodots 36 are Fe or Nb precursor nanodots, the ferroelectric nanodots 32 are formed by supplying a corresponding reaction gas under an oxygen atmosphere. The ferroelectric nanodots 32 form a monolayer of the ferroelectric nanodot layer 30.

The PbO reaction gas may be supplied by a thermal evaporation process or a sputtering process. For example, vapour state PbO may be obtained by annealing and evaporating PbO powder. Also, the vapour state PbO may be readily obtained by sputtering Pb target or PbO target installed on a sputter under a plasma atmosphere which includes oxygen O₂.

The reaction between the precursor nanodots 36 and the reaction gas may be performed in a temperature range of 400 to 900° C. If the reaction temperature is lower than 400° C., the reaction between the precursor nanodots 36 and the reaction gas may not be smoothly achieved. If the reaction temperature exceeds 900° C., the reaction gas may be vaporized from the ferroelectric nanodots 32 that are already formed.

Referring to FIG. 3D, a protective layer 41 and a lubricating layer 42 may further be formed on the ferroelectric nanodots 32. The forming of the protective layer 41 and the lubricating layer 42 are well known in the methods of manufacturing an information storage medium, and thus, descriptions thereof will be omitted.

In the method of manufacturing an information storage medium having the ferroelectric nanodots 32 consistent with the present embodiment, re-growing of the precursor nanodots 36 by contacting each other is prevented even at a high temperature of 800 to 900° C. due to the precursor nanodots 36 that are already separated when the ferroelectric nanodots 32 are formed. Therefore, the size of the ferroelectric nanodots 32 is uniform due to high temperature growing which results in a favourable crystalline structure, thereby increasing information storing characteristics.

Also, since there are nearly no gaps between the ferroelectric nanodots 32 and a write/read head portion 40 that contacts the ferroelectric nanodots 32 is relatively larger than the gaps between the ferroelectric nanodots 32, a roughness of the ferroelectric nanodots 32 is recognized to be smooth in view point of the write/read head portion.

Consistent with the present invention, since the diameter of the ferroelectric nanodots may be uniformly controlled to less than 15 nm and the ferroelectric nanodots are separated from each other, re-growing of the ferroelectric nanodots in an annealing process is prevented. Also, the ferroelectric nanodots are uniformly and spontaneously self-assembled on an electrode and a plurality of nanodots form one bit regions. Thus, the ferroelectric nanodots do not need to be precisely assembled. Accordingly, a precise patterning process is unnecessary.

Also, the ferroelectric nanodot layer consistent with the present invention is not a thin film type ferroelectric layer, but a nanodot layer in which nanodots are separated from each other. Therefore, the nanodot crystals have reduced stress, thereby improving magnetic information storing characteristics of the ferroelectric information storage medium.

The method of manufacturing a ferroelectric information storage medium consistent with the present invention is a simple and easy process, and facilitates the manufacture of a ferroelectric recording medium having improved writing characteristics.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims.

What is claimed is:

1. A ferroelectric information storage medium comprising:
a substrate;
an electrode formed on the substrate; and
ferroelectric nanodots formed on the electrode,
wherein the ferroelectric nanodots are separated from each other, and a plurality of the ferroelectric nanodots form a single bit region.

2. The ferroelectric information storage medium of claim 1, wherein the ferroelectric nanodots have a diameter of 15 nm or less.

3. The ferroelectric information storage medium of claim 1, wherein the ferroelectric nanodots are formed in a monolayer on the electrode.

4. The ferroelectric information storage medium of claim 1, wherein the ferroelectric nanodots are formed of at least one selected from PbTiO₃, KNbO₃, and BiFeO₃.

5. The ferroelectric information storage medium of claim 1, wherein the substrate is formed of at least one selected from silicon, glass and alumina.

6. The ferroelectric information storage medium of claim 1, further comprising a protective layer on the ferroelectric nanodots.

7. The ferroelectric information storage medium of claim 6, further comprising a lubricating layer on the protective layer.

8. A method of manufacturing a ferroelectric information storage medium, comprising:
a) forming an electrode on a substrate;
b) forming a precursor nanodot layer that comprises a metal material for forming a ferroelectric material on the electrode;
c) supplying a reaction gas to the precursor nanodot layer to cause a reaction with precursor nanodots of the precursor nanodot layer to form ferroelectric nanodots; and
d) forming the ferroelectric nanodots by annealing the precursor nanodot layer.

9. The method of claim 8, wherein the forming of the precursor nanodot layer comprises coordinating an organic dispersion agent on a surface of each of the precursor nanodots of the precursor nanodot layer.

10. The method of claim 8, wherein the precursor nanodot layer is formed of a plurality of precursor nanodots separated from each other.

11. The method of claim 8, wherein the precursor nanodots have a diameter of 15 nm or less.

12. The method of claim 9, wherein the forming of the precursor nanodot layer comprises thin-filming a solution in which precursor nanodots are dispersed on the electrode.

13. The method of claim 12, wherein the thin-filming is performed using at least one selected from spin coating, dip coating, blade coating, screen printing, chemical self-assembling, Langmuir-Blodgett method, and spray coating.

14. The method of claim 12, wherein the solution comprises the precursor nanodots with a concentration of 0.05 to 1 wt %.

15. The method of claim 12, wherein a solvent of the solution is at least one organic solvent selected from chloroform, dichloromethane, hexane, toluene, ether, acetone, ethanol, pyridine, and tetrahydrofuran.

16. The method of claim 8, wherein the precursor nanodot layer is a monolayer of the precursor nanodots.

17. The method of claim 9, wherein the forming of the precursor nanodot layer further comprises removing the organic dispersion agent.

18. The method of claim 17, wherein the removing of the organic dispersion agent comprises annealing the precursor nanodot layer or O₂ plasma processing the precursor nanodot layer.

19. The method of claim 9, wherein the forming of the precursor nanodot layer comprises forming precursor nanodots comprising at least one selected from Ti, Nb, and Fe.

20. The method of claim 9, wherein the forming of the ferroelectric nanodots comprises annealing at a temperature of 400 to 900° C.

21. The method of claim 9, wherein the forming of the ferroelectric nanodots comprises forming the nanodot layer of at least one selected from PbTiO₃, KNbO₃, and BiFeO₃.

22. The method of claim 8, wherein the ferroelectric nanodots have a diameter of 15 nm or less.
